(19) United States
(12) Patent Application Publication
(10) Pub. No.: US 2026/0320213 A1
(43) Pub. Date: Oct. 15, 2026

(54) SECURE REMOTE FILE ACCESS OVER A PRIVATE NETWORK

(71) Applicant: Tailscale Inc., Toronto (CA)

(72) Inventors: Percy Wegmann, Lawrence, KS (US); Rhea Ghosh, Chicago, IL (US); Samuel A. Linville, Raleigh, NC (US); Joseph Tsai, Santa Clara, CA (US)

(21) Appl. No.: 19/465,769

(22) Filed: Jan. 30, 2026

Related U.S. Application Data
(60) Provisional application No. 63/751,988, filed on Jan. 31, 2025.

(51) Int. Cl. G06F 21/62; G06F 21/31; G06F 21/60; H04L 9/40

(52) U.S. Cl. CPC G06F 21/6218; G06F 21/31; G06F 21/606; H04L 63/0442; G06F 2221/2141

(57) ABSTRACT

The technology described herein enables secure remote file access relying on security provided by a private network. In a particular example, a method provides authenticating a computing element to communicate with other authenticated computing elements over the private network using a client application executing on the computing element. A file is shared by a sharing computing element of the other authenticated computing elements over the private network. The method further provides implementing a server in the client application for a protocol for remote file management and directing a file manager on the computing element to exchange messages in the protocol at an address assigned to the server. The messages are passed through the client application to the private network. The method also provides accessing the file using the messages.

### RELATED APPLICATION

This application is related to and claims priority to U.S. Provisional Patent Application 63/751,988, titled “SECURE REMOTE FILE ACCESS OVER A PRIVATE NETWORK,” filed Jan. 31, 2025, and which is hereby incorporated by reference in its entirety.

### BACKGROUND

As computing devices have become increasingly mobile and geographically dispersed, users often access files stored across multiple machines located on different networks. Obtaining secure, consistent access to these distributed resources typically requires configuring virtual private networks, managing firewall exceptions, or deploying dedicated file-sharing servers. These approaches can impose significant administrative burden, especially in environments where users rely on varied devices and network conditions.

Remote file-management protocols enable applications to interact with files located on other machines. However, such protocols generally assume that the communicating devices are already reachable over a stable and trusted network route. Achieving this connectivity often requires separate authentication and authorization systems that operate independently from the file-sharing components. As a result, users may be required to manage multiple sets of credentials or maintain parallel configuration layers that can be prone to error.

Modern network environments complicate these challenges further. Devices frequently change IP addresses, move between networks, or become temporarily unreachable, making it difficult to maintain coherent access routes for remote file operations. Ensuring that file access remains secure and reliable across this shifting landscape can require continual coordination between network configuration, security policy, and application-level file access mechanisms.

### SUMMARY

The technology described herein enables secure remote file access relying on security provided by a private network. In a particular example, a method provides authenticating a computing element to communicate with other authenticated computing elements over the private network using a client application executing on the computing element. A file is shared by a sharing computing element of the other authenticated computing elements over the private network. The method further provides implementing a server in the client application for a protocol for remote file management and directing a file manager on the computing element to exchange messages in the protocol at an address assigned to the server. The messages are passed through the client application to the private network. The method also includes accessing the file using the messages.

In another example, an apparatus is provided having one or more computer readable storage media and one or more processing systems operatively coupled with the one or more computer readable storage media. Program instructions stored on the one or more computer readable storage media, when read and executed by the one or more processing systems, direct the apparatus to execute a client for communicating over the private network. The program instructions further direct the apparatus to, in the client register the client as a node on the private network and receive a message in a remote file management protocol from an application executing on the apparatus. The message requests access to a file stored on a destination node on the private network. The program instructions also direct the apparatus to transmit the message to the destination node over the private network.

In a further example, a system is provided including a first node on the private network configured to discover files shared by a second node over the private network, expose the files to a first file manager process at the first node, and pass messages in a file management protocol between the first file manager and the second node over the private network. The system further includes the second node on the private network configured to pass the messages in the file management protocol between the private network and a second file manager to provide the first file manager with access to the files.

### BRIEF DESCRIPTION OF THE DRAWINGS

FIG. 1 illustrates an implementation for remotely accessing files over a private network.

FIG. 2 illustrates an operation to remotely access files over a private network.

FIG. 3 illustrates an operational scenario for remotely accessing files over a private network.

FIG. 4 illustrates an implementation for remotely accessing files over a private network.

FIG. 5 illustrates an operational scenario for remotely accessing files over a private network.

FIG. 6 illustrates an operational scenario for remotely accessing files over a private network.

FIG. 7 illustrates an operational scenario for remotely accessing files over a private network.

FIG. 8 illustrates a computing system for remotely accessing files over a private network.

### DETAILED DESCRIPTION

Virtual Private Networks (VPNs) work by creating a logical network overlay that allows devices to communicate securely over underlying networks, such as a public or untrusted network (e.g., the Internet). The overlay is achieved through a process called encapsulation, where the data packets sent between devices are wrapped inside additional packets that include encrypted information. For instance, when a VPN endpoint device sends data through a VPN, a packet carrying the data is encrypted and then encapsulated with a new packet header that includes a public Internet Protocol (IP) address of another VPN endpoint device as the destination. This encapsulated packet is then sent over a public network to the destination VPN endpoint device.

At the destination VPN endpoint device, the outer packet header is stripped away to reveal the original encrypted packet. The original packet is then decrypted, allowing the data to be processed by the device. In some examples, the VPN endpoint device may be a VPN server operating as a gateway to the public network. In those examples, the decrypted original packet may be transmitted to a destination IP address on the public network identified in a header of the original packet. The above encryption method ensures that the data remains confidential and secure as it travels over potentially insecure networks, as only the VPN destination endpoint can decrypt and access the original information. By creating a secure tunnel through encryption and encapsulation, VPNs effectively simulate a private network over a public network infrastructure, providing privacy and security for users.

A Tailnet is a VPN created using Tailscale, which leverages the WireGuard protocol to provide secure, encrypted connections between devices. This network allows devices to communicate as if they were on the same local network, regardless of their physical location. Tailscale simplifies network management by eliminating the need for complex configuration or hardware setup, making it accessible for both individuals and organizations.

Nodes in a Tailnet are authenticated using a combination of modern cryptographic techniques and identity verification. Each device that joins a Tailnet must authenticate itself via an identity provider, such as Google, Microsoft, or Okta, which ensures that only nodes associated with authorized users can connect to the Tailnet. The authentication process involves exchanging cryptographic keys to establish trust between devices, ensuring that each node can securely identify and communicate with others within the network.

Once authenticated, each device receives an IP address unique within the VPN and becomes part of the Tailnet. This IP address is used to route traffic securely within the network, and all communication is encrypted using the WireGuard protocol, although other protocols may be used in other, similarly structured VPNs. Even if devices are on different underlying public networks, their data remains private and secure. Continuous authentication and authorization controls may also be implemented. This means devices are regularly verified and permissions can be adjusted dynamically. If a device's status changes or if the identity provider's credentials are updated, Tailscale can enforce new access policies in real-time, maintaining the network's security and integrity.

The security described above enables the private networks described herein to rely on that security when performing file sharing over the network. Protocols enabling file sharing over a network, such as the WebDAV (Web distributed authoring and versioning) extension to HTTP (Hypertext Transfer Protocol), support their own mechanisms to prevent unauthorized users from accessing the file share, which may or may not integrate with the same identity providers supported by the private network. The private networks in the examples below include security mechanisms preventing unauthorized access to the private network. As such, a protocol like WebDAV can be employed on the private network under the assumption that an unauthorized user would never have access to the shared files due to not having access to the private network. The private network may also implement policies to further limit access of the systems/users thereon to the shared files. This mechanism takes advantage of existing security administration features of the private network without needing to separately administer the file sharing protocol itself.

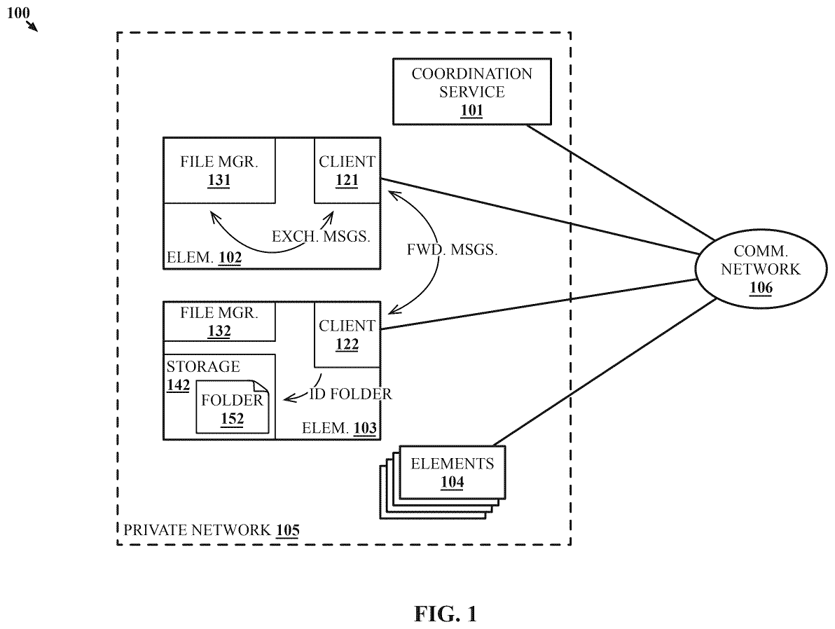

FIG. 1 illustrates implementation 100 for remotely accessing files over a private network. Implementation 100 includes coordination service 101, computing elements 102-104, and communication network 106. Coordination service 101 and computing elements 102-104 are all part of private network 105. Private network 105 is a private network, such as a VPN/Tailnet, that uses an authentication mechanism to ensure computing devices connected to private network 105 are authorized to join private network 105. Private network 105 is an overlay network on physical networking hardware of communication network 106, such as wired/wireless communication links, routers, switches, firewalls, computing devices, or other types of components for providing network communications between computing systems. Communication network 106 may include one or more Local Area Networks (LANs), Wide Area Networks (WANs), including the Internet, or some other type of data network. Communication network 106 may include one or more local area networks, wide area networks (e.g., the Internet), or some other type of network.

Computing elements 102-104 may include personal computers, laptops, smartphones, tablets, servers, virtual machines, or other types of computing devices-including combinations thereof. Computing element 102 executes network client 121 and computing element 103 executes network client 122 for communicating over private network 105. Network clients 121-122 handle the encapsulation and routing of packets over communication network 106 as part of private network 105. Although not shown, computing elements 104 may also each execute a network client for communicating over private network 105. Computing element 102 executes file manager 131 and computing element 103 executes file manager 132. A file manager is a software application that helps users, or other software applications, organize, view, and manage files and folders on their device or on other devices over a network. A file manager provides an interface to navigate through directories, allowing for tasks like copying, moving, renaming, or deleting files. File managers often include features like search, file preview, and drag-and-drop functionality to streamline file management. In this example, file manager 132 is an interface to files and folders, like folder 152, in storage 142 of computing element 103. Local storage 142 may be one or more computer readable storage media, such as hard disk(s) and/or solid state drives, built into, or an external peripheral of, computing element 103. Others of computing elements 102-104 may also include storage and file managers even though such components are not shown.

Coordination service 101 manages connections and interactions between systems and devices, such as computing elements 102-104, within private network 105. Coordination service 101 acts as a central authority that facilitates the initial authentication and ongoing management of nodes 102-104. When a device attempts to join private network 105, the device communicates with coordination service 101 to verify the device's identity, handle key exchanges, and assign network addresses. Coordination service 101, therefore, ensures only authorized devices can connect and interact with each other over private network 105 by maintaining an up-to-date directory of valid nodes and their associated credentials. As noted above, coordination service 101 may employ a third-party identity provider over communication network 106 to authenticate users and their corresponding computing elements.

Beyond authentication, coordination service 101 may also help with routing and maintaining connectivity within private network 105. Coordination service 101 may track the current network topology and support the dynamic updating of device information, such as IP addresses and connection states. This ensures that devices can efficiently discover and communicate with each other, even as they move between different underlying networks or change their connection statuses. By centralizing these functions, coordination service 101 simplifies network management and enhances the overall security and reliability. Coordination service 101 may be implemented in a single computing device or may be distributed across multiple devices. In some examples, at least a portion of coordination service 101 may be distributed across one or more of computing elements 102-104. In some examples, coordination service 101 may provide a relay facility for private-network communications, such that when two computing elements are unable to establish a direct connection over communication network 106, coordination service 101 relays encrypted traffic between the computing elements to maintain connectivity within private network 105.

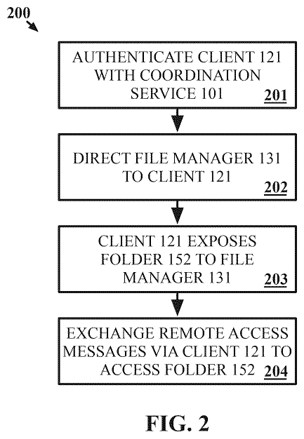

FIG. 2 illustrates operation 200 to remotely access files over a private network. Protocols like WebDAV enable remote file management for accessing files over networks. Files and the directories in which the files are stored (e.g., folders) may be accessed via a file manager interface in a manner similar to the files/directories stored locally on the computing element. To access files over a network, a file manager typically connects to an address of a system hosting the files and exchanges messages with the system in the remote file management protocol. An additional layer of security is needed, otherwise a computing element sharing files/folders would not be able to ensure the files/folders are being accessed from an authorized system. In this example, private network 105 provides that added security.

When network client 121 attempts to join computing element 102 to private network 105, network client 121 contacts coordination service 101 at a public IP address for coordination service 101 on communication network 106. In response to network client 121 requesting to join private network 105, coordination service 101 authenticates network client 121 as being allowed to join private network 105 (step 201). For example, coordination service 101 may request that network client 121 provide coordination service 101 with a secure token received from an identity provider (e.g., based on network client 121 providing valid credentials for a user of computing element 102). Coordination service 101 may then confirm with the identity provider that the token is valid and is associated with a user that is allowed to access private network 105. Other mechanisms for authenticating may also be used (e.g., coordination service 101 may validate user credentials itself rather than using a third-party identity provider). Once authenticated, coordination service 101 provides information necessary for network client 121 to communicate over private network 105. For example, coordination service 101 may provide public IP addresses on communication network 106 for computing elements 103-104, private IP addresses on private network 105 corresponding to those public IP addresses, a different public encryption key for each of computing elements 103-104 (i.e., data sent to a particular element uses the public key for that particular element), a private encryption key for network client 121 to use when decrypting packets sent from computing elements 103-104 over private network 105, network policies for private network 105, or any other type of information necessary for network client 121 to communicate securely over private network 105.

Once authenticated, network client 121 is configured as a server for the remote file management protocol to which file manager 131 can exchange messages in the protocol. File manager 131 is directed to an IP address associated with the server functionality of network client 121 (step 202). As such, from the perspective of file manager 131, the messages are being exchanged over a network even though network client 121 is on the same computing element. Communications between the file manager 131 and network client 121 are considered secure as they are both executing on computing element 102. In practice, file manager 131 communicates only with network client 121, which presents a namespace that includes a folder corresponding to the remote node and proxies the underlying protocol traffic to the appropriate remote client (e.g., client 122 on computing element 103) that actually serves folder 152.

Prior to exposing any shared folders to file manager 131, network client 121 exchanges remote access discovery messages over private network 105 to identify files and folders shared by other authenticated computing elements. In particular, network client 121 transmits a discovery request to other network clients on private network 105, including network client 122. In response, network client 122 indicates that folder 152 is available for sharing on computing element 103, thereby enabling network client 121 to learn of the existence and availability of folder 152.

In this example, network client 122, which has also been authenticated by coordination service 101 to communicate over private network 105, has been directed to share folder 152 over private network 105. For example, network client 122 may present an interface to a user of computing element 103, which may be the same user as the user of computing element 102, enabling the user to indicate which files and/or folders stored in local storage 142 should be made available for access over private network 105. Based on the discovery responses described above, network client 121 exposes folder 152 to file manager 131 (step 203). Network client 121 forwards information identifying folder 152 to file manager 131, which may present folder 152 in an interface to a user of computing element 102. In some examples, file manager 131 may present computing element 103 as a top level directory in which folder 152 is contained, thereby indicating the system that stores folder 152.

Network client 121 forwards the response from network client 122 to file manager 131 and file manager 131 may present folder 152 in an interface to the user of computing element 102. In some examples, file manager 131 may present computing element 103 first as a top level directory in which folder 152 is contained. This enables a user to recognize which system contains folder 152. Additional messages may be exchanged with network client 122 via network client 121 to enable file manager 131 to access folder 152 and its contents (step 204). For example, the user of computing element 102 may open folder 152 to view files or subdirectories, open a file, copy files to storage on computing element 102, or perform some other action with folder 152.

Since all the messages are exchanged between network clients over private network 105 and are, therefore, encrypted when traversing public communication network 106, users of computing elements on private network 105 are ensured that only other authorized users/computing elements are accessing shared folders. Likewise, network policies for private network 105 may be enforced by clients on computing elements 102-104 to further limit who can access shared files/folders. For example, a network policy may indicate that only network client 121 can access folder 152. Network client 122 may then block messages for accessing folder 152 from computing elements 104 accordingly.

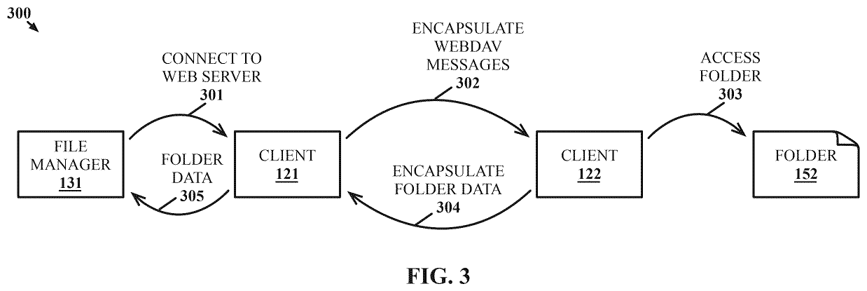

FIG. 3 illustrates operational scenario 300 for remotely accessing files over a private network. Operational scenario 300 is an example of how data from folder 152 may be shared over private network 105. File manager 131 connects to a web server component of network client 121 (step 301). The web server component has an address that routes internally within computing element 102 from file manager 131 to network client 121. In this example, network client 121 has been authenticated for accessing private network 105. File manager 131 exchanges WebDAV messages with network client 121, which encapsulates those messages for transmission over private network 105 (step 302). The encapsulation includes encrypting the messages using an encryption key for network client 122 (i.e., an encryption key which coordination service 101 determined communications with network client 122 should use). The encapsulated packets are sent to a public IP address of computing element 103. If any of the messages are also sent to one or more of computing elements 104, then network client 121 similarly encapsulates the messages using the different keys used by the network clients at those elements, as designated by coordination service 101.

Upon receipt of the messages, network client 122 decrypts the data in the encapsulated packet and identifies the messages as being WebDAV messages for remote file/folder access. Network client 122, therefore, allows access to folder 152, as requested by the messages (step 303). Response WebDAV messages and any data from folder 152 that is requested by file manager 131 are sent in encapsulated packets back to network client 121 (step 304). Network client 122 uses an encryption key designated by coordination service 101 for use on communications with network client 121 to encrypt the data prior to sending the encrypted packets to a public IP address of network client 121. Network client 121 decrypts the received packets using the key. The server component of network client 121 then provides the decrypted data to file manager 131 (step 305).

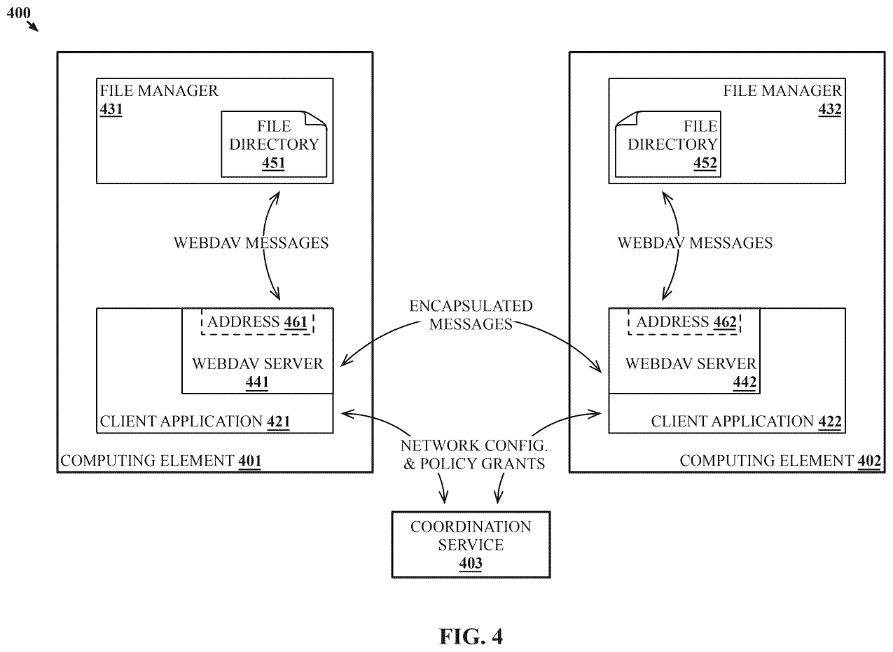

FIG. 4 illustrates implementation 400 for remotely accessing files over a private network. Implementation 400 includes computing element 401, computing element 402, and coordination service 403. Computing element 401 executes client application 421 and computing element 402 executes client application 422 to join computing element 401 and computing element 402 as nodes to a private network. Although two computing elements are depicted for clarity, the private network may include any number of nodes managed under common administrative control or distributed among multiple administrative domains. In some examples, the nodes may be physical machines, virtual machines, containers, mobile devices, or network appliances operating diverse operating systems. Coordination service 403 authenticates client application 421 and client application 422 as authorized participants of the private network and distributes network configuration information—such as private network addresses, public network addresses, and per-peer encryption keys—that the client applications use to communicate over the private network. Coordination service 403 may further distribute policy grants that define explicit permissions for network activities, including which nodes are permitted to communicate, which applications or services may be invoked by which nodes, and which nodes may expose files for access by other nodes. In some deployments, coordination service 403 simultaneously administers multiple private networks and may synchronize policies or keys across those networks subject to tenant boundaries and administrative roles.

In this example, client application 421 and client application 422 each include an embedded server for a remote file management protocol—illustrated as WebDAV server 441 and WebDAV server 442, respectively. In further examples, the embedded server may implement other protocols such as SFTP, SMB, NFS, a RESTful object interface, or a FUSE-backed virtual filesystem interface; the techniques described herein apply regardless of the specific remote file management protocol selected. WebDAV server 441 is bound to local network address 461, enabling applications executing on computing element 401 to communicate with WebDAV server 441 at address 461 as though it were a conventional network file server. WebDAV server 442 is similarly bound to local network address 462 for applications on computing element 402. File manager 431 and file manager 432 are representative applications that exchange WebDAV messages with WebDAV server 441 and WebDAV server 442, respectively, although other applications (e.g., backup tools, synchronization utilities, or command-line clients) may also access these servers using the same local addresses. In some implementations, the local addresses 461-462 are stable, well-known endpoints, such as loopback or overlay addresses, allowing applications to mount shared resources consistently across reboots or network changes.

In operation, client application 421 and client application 422 communicate over the private network using encapsulated and encrypted messages, while file manager 431 and file manager 432 mount and browse remote files and folders by exchanging WebDAV messages with their respective local servers 441-442. In the illustrated example, file manager 431 presents file directory 451 and file manager 432 presents file directory 452, enabling users to navigate, open, copy, move, or delete files. In some cases, directory views 451-452 include logical namespaces that identify the remote device and share from which a file originates, thereby providing a consistent path structure when multiple remote shares are mounted. When a request targets a file stored on the other computing element, the local server (e.g., WebDAV server 441 at local network address 461) maps the locally received request to a corresponding resource address at the remote element (e.g., a path served by WebDAV server 442 at local network address 462), evaluates applicable policy grants obtained from coordination service 403, and, if permitted, encapsulates the request using the keys and addressing information distributed by coordination service 403 before transmitting the request over the private network. Responses from the remote element are decapsulated by the receiving client application and delivered back to the originating file manager, allowing the user to interact with remote files as if they were local while maintaining end-to-end policy enforcement and transport security. In alternative embodiments, the client application may perform request throttling, request retry with backoff, or opportunistic read caching to improve user experience during varying network conditions.

Although WebDAV is used in the example of FIG. 4, similar operations may be performed for other remote file management protocols. For instance, an SFTP server embedded within client application 421 could be bound to address 461 to accept SFTP sessions from a local application, with the client application translating session operations into encapsulated messages addressed to the remote node. Likewise, an SMB or NFS endpoint may be hosted locally and proxied over the private network using the same coordination, key distribution, and policy evaluation mechanisms described above. The selection of protocol may depend on operating-system capabilities, administrative preference, application compatibility, or performance constraints, and may be changed dynamically or negotiated at mount time. Regardless of the protocol, coordination service 403 continues to provide authentication, keying material, addressing information, and policy grants used by client applications 421-422 to authorize and secure communications between nodes.

In some implementations, the client applications 421-422 additionally record operational events—such as access denials due to policy, successful file reads, or failed write attempts with conflict indications—and may export those events to a log facility for auditing or troubleshooting. In other implementations, the client applications perform local staging of write data prior to transmission, verify completion or integrity of the staged data, and then transmit the data to the remote node, thereby reducing the likelihood of partially written files during intermittent connectivity. These behaviors are optional and may be configured per device, per share, or per user role through policy grants distributed by coordination service 403.

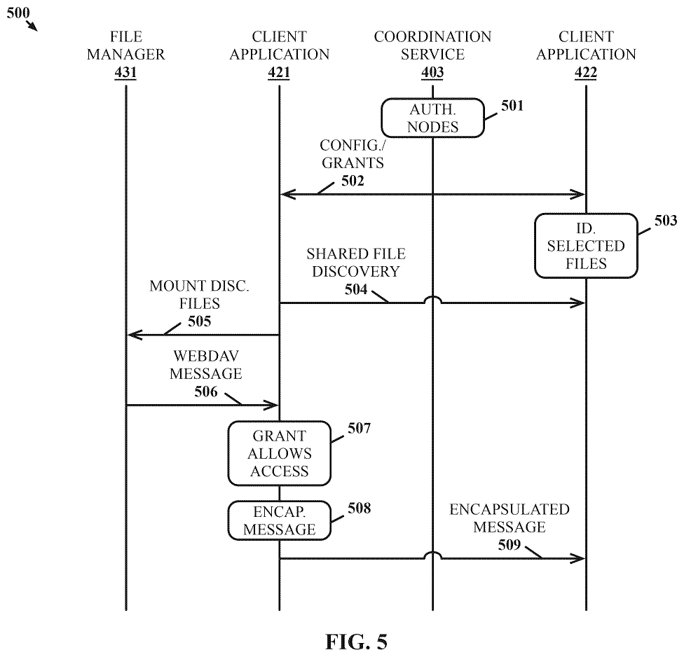

FIG. 5 illustrates operational scenario 500 for remotely accessing files over a private network. In operational scenario 500, coordination service 403 authenticates client application 421 and client application 422 to access the private network (step 501). In some implementations, each client provides user and/or device credentials to the coordination service and registers as an active node so that subsequent messages can be associated with an authenticated identity and device posture. In other examples, an Identity Provider (IdP) may be employed to authenticate users of client application 421 and client application 422. Upon receiving authentication confirmation from the IdP, coordination service 403 may then determine that the authenticated users are allowed to access the private network via client application 421 and client application 422. In some examples, client application 421 and client application 422 may be associated with the same user. Authentication may be renewed periodically or upon policy changes to maintain continuous assurance.

Upon determining that client application 421 and client application 422 are allowed to access the private network, coordination service 403 provides network configuration information and policy grant information to client application 421 and client application 422 (step 502). This distribution can include private network addresses, public network addresses, and public encryption keys for respective peers so that client applications 421-422 can encrypt and authenticate traffic end-to-end. The encryption and authentication enable the file sharing described herein to rely on the authentication already provided by the private network. While steps 501-502 are shown to occur at the same time for both client application 421 and client application 422, client application 422 may request to join the private network at a different time than client application 421. Nodes may join, leave, or roam at different times; keys, addresses, and grants can therefore be refreshed on demand so that nodes communicate securely even as topology and connectivity change. Policy grants supplied at this stage may govern which folders a node may expose, which remote nodes may read or write particular files, and which protocol operations are permitted.

Client application 422 identifies files that a user has selected for sharing over the private network (step 503). A user may select a folder that contains one or more files, and sharing the folder implicitly shares the files located in that folder. The selection can be made through a graphical user interface, a command-line interface, or configuration deployed by an administrator. In some examples, the user may further provide conditions on the access of certain files and folders. The conditions may include who can access a file/folder, when the file/folder can be accessed, from where the file/folder can be accessed, a type of access (e.g., read-only), or some other type of restriction on access—including combinations thereof. In response to user selections, the client may prepare or update grants for distribution by the coordination service. Client application 421 performs shared file discovery to discover shared files and folders from other nodes on the private network (step 504). Discovery can be performed by querying a registry maintained by the coordination service, receiving advertisements from peers, and/or aggregating responses from nodes that publish their currently shared resources. Discovery results may be filtered so that only resources for which access is potentially permitted are presented to the requester.

File manager 431 mounts the discovered files and folders via WebDAV server 441 (step 505). The mounting action establishes a local namespace through which remote resources appear to the file manager as if they were locally hosted. The WebDAV message includes a URL identifying the requested file within the local WebDAV namespace exposed at address 461, consistent with the HTTP-based addressing used by WebDAV. To access one of the files, file manager 431 sends a WebDAV message requesting the file to local network address 461, which routes the message to WebDAV server 441 of client application 421 (step 506). In some implementations, WebDAV server 441 is a local endpoint (e.g., loopback or overlay address) so that all protocol messages from the file manager are first received by the client application on the same computing element. This arrangement also enables the client to present a consistent mount point across reboots or network changes.

Determine that a policy grant received from coordination service 403 allows client application 421 to request the file (step 507). Client application 421 may evaluate grants using attributes such as the requesting node identity, the destination node identity, the name of the selected share, the requested operation (e.g., GET, PUT), and time- or role-based conditions. In response to identifying the policy grant, client application 421 encapsulates the message using address and encryption key information for client application 422 received from coordination service 403 (step 508). Prior to encapsulation, the client may confirm the current public network address and public encryption key associated with the destination node and, when necessary, refresh such information from coordination service 403 so the encapsulated payload is routable and correctly protected. Address translation can additionally be performed so that a local path or URL used by the file manager is mapped to a corresponding private-network address or URL for the file that the remote node recognizes. Client application 421 then sends the encapsulated message to client application 422 (step 509).

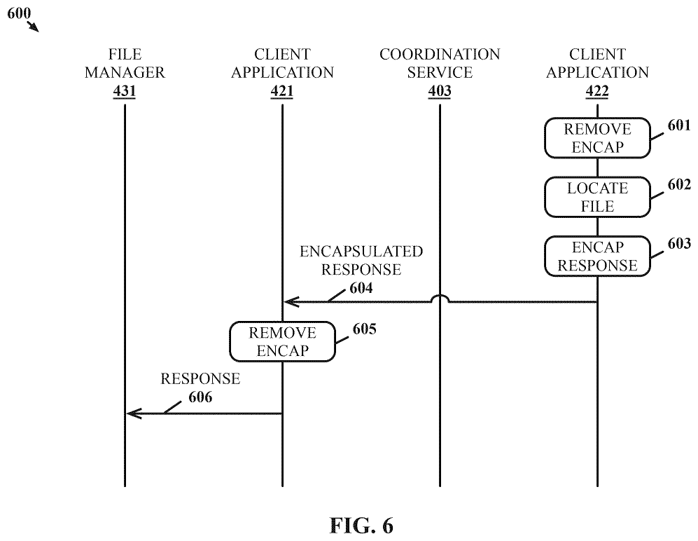

FIG. 6 illustrates operational scenario 600 for remotely accessing files over a private network. Operational scenario 600 is a continuation of operational scenario 500. Upon client application 422 receiving the encapsulated message from client application 421, client application 422 removes the encapsulation (step 601). Decapsulation can include verifying integrity and freshness information and recovering the inner message in the remote file management protocol. The WebDAV message extracted from the encapsulation includes a URL that identifies the target file relative to the WebDAV server hosted by client application 422, enabling the client to resolve the URL to a corresponding file in the shared folder. Client application 422 locates the file identified in the WebDAV message extracted from the encapsulation so that the file can be supplied to client application 421 in a response (step 602). Locating the file may involve resolving a translated path into a concrete filesystem path within a currently shared folder and confirming that the share remains active under the applicable policy grants.

Client application 422 generates a response with the file data and encapsulates the response (step 603). Client application 422 may populate protocol headers (e.g., content length, entity tags) and optionally apply chunking or compression for efficient transfer. Client application 422 transmits the encapsulated response to client application 421 (step 604). Client application 421 removes the encapsulation (step 605). Client application 421 passes the response to file manager 431 (step 606).

In an alternative implementation, client application 422 may pass the access-request message in the protocol to a second file manager executing on computing element 402, receive a protocol response containing the file data from that second file manager, and then transmit that response over the private network to the requesting node. For write operations initiated at client application 421, the client can receive a write request from file manager 431, stage data in a temporary object until the write is complete, and—after verifying completion—transmit the staged data to the destination; if a second write request to the same file is detected from another authenticated node while staging is in progress, the client can signal a conflict to file manager 431 and proceed with transmission only after the conflict is resolved at the file manager.

Advantageously, by passing WebDAV messages between a node accessing a file and a node storing that file, the private network enables applications on those nodes to operate as though they are exchanging WebDAV communications with a standard WebDAV server.

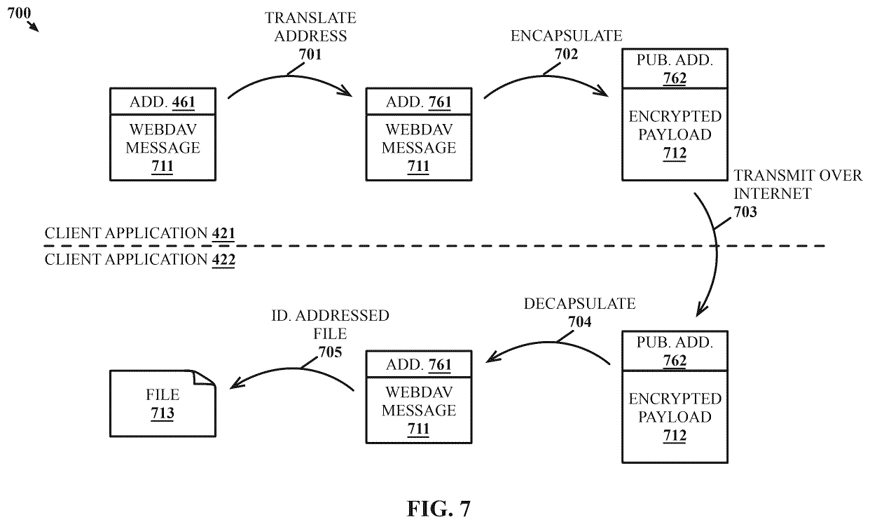

FIG. 7 illustrates operational scenario 700 for remotely accessing files over a private network. Operational scenario 700 describes another example of steps performed by client application 421 and client application 422 when exchanging WebDAV messages. In operational scenario 700, client application 421 receives WebDAV message 711 from an application (e.g., file directory 451). WebDAV message 711 is directed to local network address 461 and includes an address identifying file 713 relative to local network address 461. WebDAV message 711 includes a URL identifying file 713 relative to the local WebDAV namespace exposed at address 461. Since that local URL is meaningful only within client application 421, client application 421 translates the address to file address 761, which identifies file 713 external to client application 421 (step 701). In some examples, the translation composes a private network identifier, a device or node identifier for the remote element, and a share identifier corresponding to the shared folder that contains the file so that the resulting address or URL uniquely references the resource across the private network.

Client application 421 encapsulates WebDAV message 711 using an encryption key associated with client application 422 to create encrypted payload 712 (step 702). The encryption key used to encrypt WebDAV message 711 may be a public encryption key for client application 422 supplied by coordination service 403 or may be an encryption key exchanged between client application 421 and client application 422 after establishing a connection tunnel using the public key provided by coordination service 403. Client application 421 transmits encrypted payload 712 over the Internet to public network address 762 of client application 422 (step 703). Coordination service 403 may have supplied public network address 762 and client application 421 may track that file address 761 is stored at client application 422. In some implementations, the client first determines the current public encryption key and public network address for the remote node before encapsulation, and may attempt direct peer connectivity discovered through NAT traversal or else use a relay path if direct connectivity is unavailable.

Upon receiving encrypted payload 712, client application 422 decapsulates encrypted payload 712 to retrieve WebDAV message 711 therein (step 704). Client application 422 identifies file 713 from file address 761 (step 705). Identification may include validating that the resolved path corresponds to a currently shared resource and applying policy checks specific to the operation type. When the message is a read request, client application 422 accesses the file and prepares a response as noted above; when the message is a write request, client application 422 enforces any permissions indicated by the applicable grants (e.g., read-only vs. read-write) and either applies the update or returns a protocol error. In the alternative embodiment that involves a second file manager, client application 422 passes the message between the private network and the second file manager to provide the requesting file manager with access to the files, enabling the same end-to-end behavior using a different local service component.

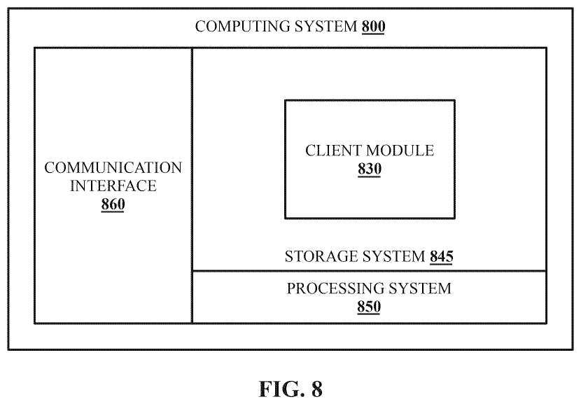

FIG. 8 illustrates computing system 800 for remotely accessing files over a private network. Computing system 800 is representative of any computing system or systems with which the various operational architectures, processes, scenarios, and sequences disclosed herein can be implemented. Computing system 800 is an example architecture for coordination service 101 and computing elements 102-108, although other examples may exist. Computing system 800 includes storage system 845, processing system 850, and communication interface 860. Processing system 850 is operatively linked to communication interface 860 and storage system 845. Communication interface 860 may be communicatively linked to storage system 845 in some implementations. Computing system 800 may further include other components such as a battery and enclosure that are not shown for clarity.

Communication interface 860 comprises components that communicate over communication links, such as network cards, ports, radio frequency (RF), processing circuitry and software, or some other communication devices. Communication interface 860 may be configured to communicate over metallic, wireless, or optical links. Communication interface 860 may be configured to use Time Division Multiplex (TDM), Internet Protocol (IP), Ethernet, optical networking, wireless protocols, communication signaling, or some other communication format including combinations thereof. Communication interface 860 may be configured to communicate with other computing systems via one or more networks.

Processing system 850 comprises microprocessor and other circuitry that retrieves and executes operating software from storage system 845. Storage system 845 may include volatile and nonvolatile, removable, and non-removable media implemented in any method or technology for storage of information, such as computer readable instructions, data structures, program modules, or other data. Storage system 845 may be implemented as a single storage device but may also be implemented across multiple storage devices or sub-systems. Storage system 845 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no interpretation would storage media of storage system 845, or any other computer-readable storage medium herein, be considered a transitory form of signal transmission (often referred to as “signals per se”), such as a propagating electrical or electromagnetic signal or carrier wave.

Processing system 850 is typically mounted on a circuit board that may also hold the storage system. The operating software of storage system 845 comprises computer programs, firmware, or some other form of machine-readable program instructions. The operating software of storage system 845 comprises client module 830. The operating software on storage system 845 may further include an operating system, utilities, drivers, network interfaces, applications, or some other type of software. When read and executed by processing system 850 the operating software on storage system 845 directs computing system 800 to share files and folders over a private network, as described herein. Client module 830 may execute natively on processing system 850 or the operating software may include virtualization software, such as a hypervisor, to virtualize computing hardware on which client module 830 executes.

In at least one example, client module 830 executes on processing system 850 and directs processing system 850 to authenticate computing system 800 to communicate with other authenticated computing elements over a private network using. At least one folder and/or file is shared by a sharing computing element of the other authenticated computing elements over the private network. Client module 830 directs processing system 850 to implement a server in the client application for a protocol for remote file management and exchanges, with a file manager for computing system 800, messages in the protocol at an address assigned to the server and pass the message through to the private network so the file manager can access the at least on folder and/or file using the messages.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method for sharing files over a private network, the method comprising:
authenticating a computing element to communicate with other authenticated computing elements over the private network using a client application executing on the computing element, wherein a file is shared by a sharing computing element of the other authenticated computing elements over the private network;
implementing a server in the client application for a protocol for remote file management;
directing a file manager on the computing element to exchange messages in the protocol at an address assigned to the server, wherein the messages are passed through the client application to the private network; and
accessing the file using the messages.

2. The method of claim 1, wherein authenticating the computing element comprises:
authenticating a user of the computing element to a coordination service for the private network;
providing a public encryption key to the coordination service, wherein the coordination service distributes the public encryption key to the other authenticated computing elements for encrypting communications sent to the computing element; and
receiving, from the coordination service, additional public encryption keys for use by the client application to encrypt communications sent to respective elements of the other authenticated computing elements.

3. The method of claim 1, comprising:
transmitting, from the client application, a share-discovery request to at least one of the other authenticated computing elements;
aggregating responses received from the other authenticated computing elements indicating available files shared by the other authenticated computing elements; and
indicating available files to the file manager.

4. The method of claim 1, wherein the file is located in a folder, and the folder is shared by the sharing computing element to share the file.

5. The method of claim 1, wherein accessing the file using the messages comprises, in the client application:
receiving a message of the messages; and
in response to identifying at least one policy granting permission for the message, transmitting the message over the private network.

6. The method of claim 1, comprising, in the client application:
receiving policy grants from a coordination service for the private network, wherein the policy grants define what communications are allowed between which computing elements on the private network, wherein at least one of the policy grants indicates the file can be shared by the sharing computing element to the computing element.

7. The method of claim 1, comprising, in the client application:
presenting a user interface for share configuration;
receiving user input via the user interface indicating one or more files to be shared over the private network from the computing element; and
exposing the one or more files for sharing over the private network.

8. The method of claim 7, comprising:
receiving second user input via the user interface indicating a subset of the other authenticated computing elements allowed to access the one or more files; and
creating a policy grant for distribution to the subset allowing the subset to access the one or more files.

9. The method of claim 7, comprising:
receiving an access-request message in the protocol over the private network requesting access to a target file of the one or more files;
passing the access-request message to the file manager;
receiving the target file in a response message in the protocol from the file manager; and
transmitting the response message over the private network.

10. The method of claim 1, wherein a message of the messages is directed to an address assigned to the file in the server, and wherein accessing the file comprises:
translating the address to a corresponding private-network address for the file before transmitting the message over the private network.

11. The method of claim 1, wherein accessing the file using the messages comprises, in the client application:
receiving a write request in one of the messages to modify the file;
staging data of the write request in a temporary object; and
in response to verifying completion of the data, transmitting the data over the private network.

12. The method of claim 11, comprising:
in response to detecting a second write request to the file from another authenticated computing element while the data is being staged, signaling a conflict to the file manager, wherein the data is transmitted after resolving the conflict in the file manager.

13. An apparatus for sharing files over a private network, the apparatus comprising:
one or more computer readable storage media;
one or more processing systems operatively coupled with the one or more computer readable storage media; and
program instructions stored on the one or more computer readable storage media that, when read and executed by the one or more processing systems, direct the apparatus to:
execute a client for communicating over the private network; and
in the client:
register the client as a node on the private network;
receive a message in a remote file management protocol from an application executing on the apparatus, wherein the message requests access to a file stored on a destination node on the private network; and
transmit the message to the destination node over the private network.

14. The apparatus of claim 13, wherein the program instructions direct the apparatus to:
receive a response message in the remote file management protocol over the private network from the destination node, wherein the response message includes data of the file; and
forward the message to the application.

15. The apparatus of claim 13, wherein the client hosts a remote file server assigned a local network address enabling the application to mount shared resources including the file.

16. The apparatus of claim 13, wherein to transmit the message, the program instructions direct the apparatus to:
determine a public encryption key and public network address associated with the destination node;
encrypt the message using the public encryption key to generate an encapsulated payload; and
transmit the encapsulated payload to the public network address.

17. The apparatus of claim 13, wherein to transmit the message, the program instructions direct the apparatus to:
translate an address for the file used by the application to an address for the file on the private network.

18. A system for sharing files over a private network, the system comprising:
a first node on the private network configured to:
discover files shared by a second node over the private network;
expose the files to a first file manager process at the first node; and
pass messages in a file management protocol between the first file manager and the second node over the private network; and
the second node on the private network configured to:
pass the messages in the file management protocol between the private network and a second file manager to provide the first file manager with access to the files.

19. The system of claim 18, comprising:
a coordination service for the private network configured to distribute encryption keys and network addresses for the first node and the second node to exchange private network communications.

20. The system of claim 19, comprising:
the coordination service configured to distribute a policy grant to the first node and the second node enabling the first node to access the files.
